(19) United States
(12) Patent Application Publication
(10) Pub. No.: US 2005/0102776 A1
(43) Pub. Date: May 19, 2005

(54) Head for a toothbrush

(76) Inventor: Soni Mathur, Lake Worth, FL (US)

Correspondence Address: Robert M. Downey;ROBERT M. DOWNEY, P.A., Suite 300, 601South Federal Highway, Boca Raton, FL, 33432, US

(21) Appl. No.: 10/713,496

(22) Filed: Nov. 14, 2003

(51) Int. Cl. A61C 17/22

(52) U.S. Cl. 15/22.1; 15/22.2; 15/28

(57) ABSTRACT

A head for a toothbrush has a motion directing assembly structured for rotating a first set of bristles in an oscillating motion through an arc of rotation about a central rotational axis while simultaneously moving the first set of bristles in a linear reciprocating motion generally parallel to the central rotational axis. In further embodiments, a second set of bristles is moved as well, and in an oscillating motion through an arc of rotation about the same central rotational axis as the first set of bristles, in the opposite rotational direction, while simultaneously moving in a linear reciprocating motion in the opposite linear direction relative to the first set of bristles, such that as one set of bristles is moving inwardly, the other set of bristles is moving outwardly relative to the brush head. In further embodiments, multiple first and second sets of bristles are arranged in pairs, wherein the first and second sets of bristles in each pair are driven in both the oscillating motion and linear reciprocating motion, in opposite directions relative to one another.

### BACKGROUND OF THE INVENTION

1. Field of the Invention

The present invention relates generally to electric toothbrushes and, more particularly, to an electric toothbrush providing dual action bristle motion and, more specifically, oscillating motion of bristles about an arc of rotation and simultaneous reciprocating motion of the bristles away from and back towards the toothbrush head to create a pumping-type action for effectively cleaning tooth surfaces and inter-proximal crevices between teeth.

2. Discussion of the Related Art

The benefits of brushing one's teeth using motorized toothbrushes are well known, and motorized movement in toothbrushes has been the subject of much recent innovation and design activity. Also, the commercial market has seen the introduction, over the last several years, of many different types of motorized toothbrushes. However, an examination of the available technology shows a tendency toward increasingly complex, expensive, and non-commercially feasible methods of achieving motorized motions in the bristles and heads of toothbrushes to aid in more effectively cleaning one's teeth.

The commercial marketplace has become divided into two price markets. On the higher priced end are some of these more complex motorized toothbrushes that provide various motions to the bristles and brush head. The lower end of the market has become the province of very simple motorized toothbrushes that only vibrate through the use of an offset weight attached to the motor shafts and which provide very little true additional cleaning benefit with their use, since no vigorous motion is transmitted to the cleaning surface of the brush. The vibrations are also very uncomfortable to the hand and act to discourage brushing one's teeth for an adequate period of time.

Numerous electric toothbrushes have been developed over the years. Some known devices are shown in U.S. Pat. Nos. 5,070,567; 5,186,627; 5,274,870; 5,341,534; 5,378,153; 5,732,433; and 6,360,395. The disadvantage of these devices is that bristles lack an up and down movement relative to the brush head and therefore perform less than optimal in cleaning tooth surfaces. Another disadvantage is that these devices lack bristle arrangement to clean hard-to-access crevices between teeth. The device shown in U.S. Pat. No. 6,574,820 discloses an embodiment in which an inter-dental probe moves up and down relative to a second set of bristles. This embodiment provides enhanced cleaning of the crevices between tooth surfaces. However, the disadvantage is that the inter-dental probe does not rotate (thereby does not provide the benefits of bristle twisting motion). Another disadvantage is that the second set of bristles does not move up and down (thereby does not provide the additional cleaning benefits resulting from a pumping up-and-down oscillating motion of bristles on tooth surfaces). Accordingly, it has been considered desirable to develop a new and improved electric toothbrush which would overcome the foregoing difficulties and others while providing better and more advantages.

### SUMMARY OF THE INVENTION

The present invention is directed to a toothbrush head which provides a dual action bristle motion, including an oscillating motion and a simultaneous linear reciprocating motion of at least one set of bristles. In several preferred embodiments, the brush head is adapted for use with an electric toothbrush having an elongated body with a hollow interior defining a housing. The elongated body includes a handle portion, a head and a neck extending between the handle portion and the head. A motor contained and supported within the handle portion is disposed in driving engagement with a drive assembly. The drive assembly includes a swivel arm arrangement having a distal end disposed within the head portion of the elongated body. The swivel arm arrangement is operatively driven by the motor to move the distal end in a reciprocating motion. A bristle member is fitted to the head portion of the elongated body and is movable about a central rotational axis.

The bristle member includes a first portion movably captivated within the interior of the head portion of the housing, and a second portion disposed on an exterior of the bottom face of the head. The second portion of the bristle member includes a bristle support structure with a first set of bristles extending outwardly therefrom and arranged in a generally circular pattern about the central rotational axis. A motion directing assembly is structured and disposed for moving the bristle support structure and the attached first set of bristles in an oscillating motion through an arc of rotation about the central rotational axis. The motion directing assembly is further structured for simultaneously directing the bristle support structure and the attached first set of bristles in a linear reciprocating motion away from and back towards the bottom face of the head portion and generally parallel to the central rotational axis.

In several further embodiments of the invention, a second set of bristles is movably supported on the head portion and the motion directing assembly is structured and disposed for simultaneously moving both the first set of bristles and the second set of bristles, wherein both sets of bristles oscillate in opposite directions about the central rotational axis, while simultaneously moving in the linear reciprocating motion. When moving in the linear reciprocating motion, the first set of bristles moves in the opposite direction to the second set of bristles so that when the first set of bristles is raised towards the head, the second set of bristles is lowered away from the head, and when the first set of bristles is lowered away from the head, the second set of bristles is raised towards the head.

In still further embodiments of the invention, multiple first and second sets of bristles are provided and arranged in corresponding pairs, with each pair consisting of a first set of bristles and a second set of bristles. The first and second sets of bristles in each pair are driven by the motion directing assembly in both the oscillating motion and linear reciprocating motion, in opposite directions, in a manner similar to the previously described embodiments.

Objects and Advantages of the Invention

It is a primary object of the present invention to provide a controlled and predetermined oscillating up-and-down motion of bristles in a motorized toothbrush, thereby creating a pumping-type action to effectively clean tooth surfaces and access difficult-to-reach crevices between the teeth.

It is a further object of the present invention to provide a motorized toothbrush with two sets of bristles moving in an up-and-down manner (in opposite directions from one another) while oscillating/rotating (in opposite directions from one another) and wherein the first set of bristles extends to its maximum length to effectively penetrate crevices between the teeth while the second set of bristles withdraws to its minimum length to allow the first set of bristles to achieve maximum penetration and further where the first set of bristles withdraws to its minimum length while the second set of bristles extends to its maximum length to effectively clean tooth surfaces.

It is still a further object of the present invention to provide a motorized toothbrush with two sets of bristles and wherein the bristle sets are moved in an alternating up-and-down action while each oscillating set of bristles rotates, thereby providing a unique and superior cleaning action that targets both tooth surfaces and inter-proximal crevices between teeth.

Other objects, features, and advantages of the invention will become apparent upon reading the following detailed description in conjunction with the accompanying drawings.

### DESCRIPTION OF DRAWINGS

For a fuller understanding of the present invention, reference should be made to the following detailed description taken in conjunction with the accompanying drawings in which:

FIG. 1 is a perspective view in accordance with the first preferred embodiment of the present invention;

FIG. 1B is an exploded view illustrating relation of disk with brush head floor;

FIG. 1C is a front view illustrating the bristles in an up position;

FIG. 1D is a front view illustrating the bristles in a down position;

FIG. 2A is an exploded view illustrating relation of disk with top of brush head;

FIG. 2B is an exploded view of alternate embodiment illustrating relation of disk with top of brush head;

FIG. 3 is a side view illustrating relationship of disk with wall of brush head;

FIG. 4A is an exploded view illustrating relation of disk with brush head floor;

FIG. 4B is a side view of disk illustrating position of protruding feet;

FIG. 4C is a bottom plan view of brush head floor;

FIG. 4D is a front view with bristle in an up position;

FIG. 4E is a front view with bristle in a down position;

FIG. 6C is a front view illustrating first set of bristles in an up position and second set of bristles in a down position;

FIG. 6D is a top plan view;

FIG. 6E is a bottom plan view;

FIG. 6F is an exploded view;

FIG. 7 is an exploded view;

FIG. 8A is an exploded view;

FIG. 8B is a top plan view;

FIG. 8C is a front sectional view taken along line 8C-8C in FIG. 8B;

FIG. 8D is a side view;

FIG. 9A is a top plan view;

FIG. 9B is a front view;

FIG. 9C is a side view illustrating relation of rack with drive gears;

FIG. 10A is a perspective view;

FIG. 10B is a top plan view;

FIG. 10C is a front view;

FIG. 10D is a side view.

### DETAILED DESCRIPTION OF THE PREFERRED EMBODIMENTS

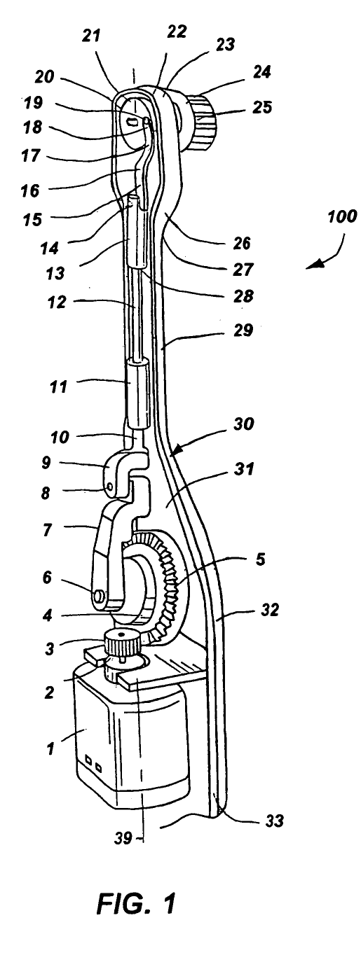

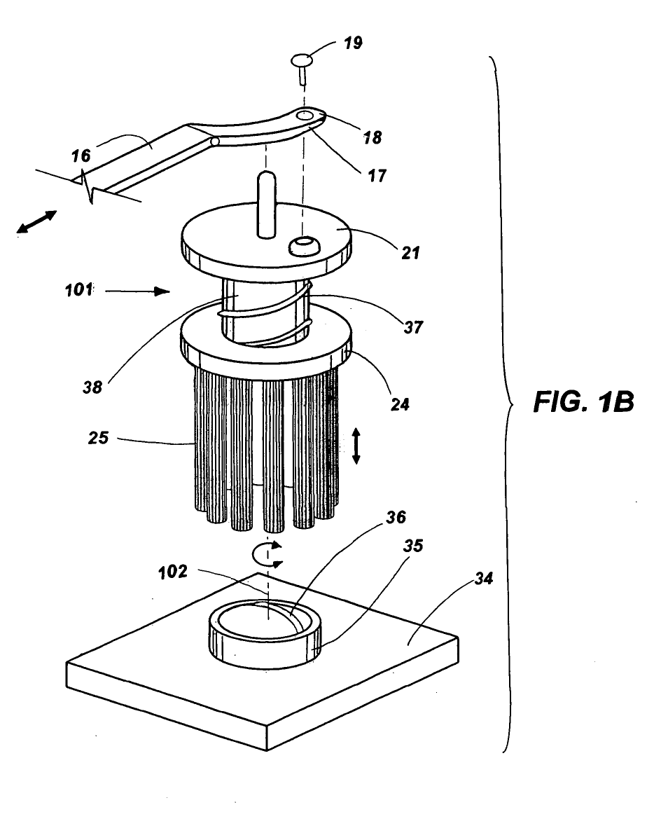

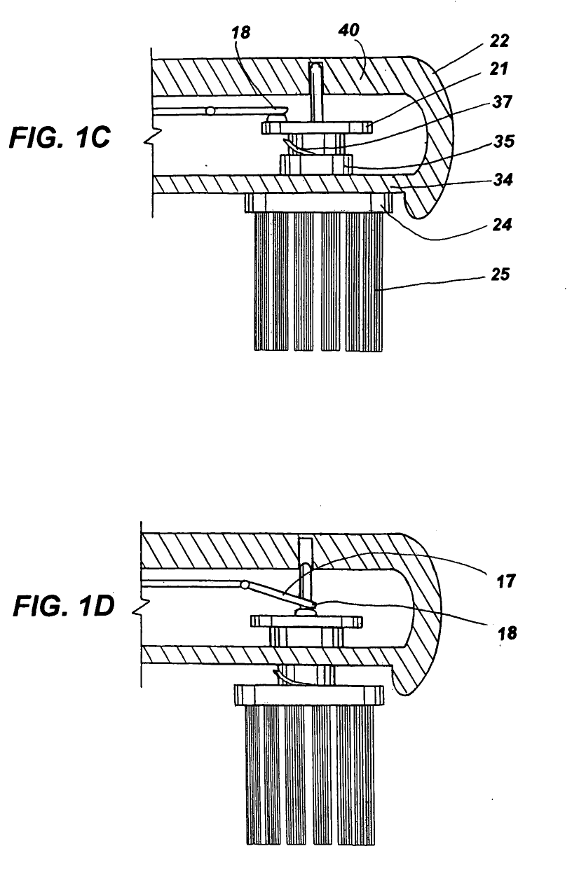

FIG. 1 illustrates an electric toothbrush 100 which has an elongated body 30. A first end 27 of the elongated body 30 has a head 23 and the opposite second end 32 defines a handle 33. The elongated body portion 30 further includes an angled neck 29 which is located between the head 23 and the handle 33. Angled shaft 29 is parallel with the longitudinal axis 39 of the elongated body portion 30. The elongated body portion 30 also includes a hollow portion 31 which houses a motor 1. The motor 1 provides power to the bristle supporting structure 24 to rotate in an oscillating action. Power is provided to the motor by a battery (not shown).

A first gear 2 is operatively connected to and powered by the motor 1. The first gear 2 rotates about the longitudinal axis 39. A second gear 4 is operatively connected to the first gear 2. The second gear 4 is approximately normal to the first gear 2. The second gear 4 is preferably a bevel gear and rotates about an axis approximately perpendicular to the longitudinal axis 39. Teeth 3 of the first gear 2 mesh with teeth 5 of the second gear 4 causing second gear 4 to rotate when first gear 2 rotates.

A swivel arm arrangement is linked between the second gear 4 and the bristle supporting structure 24. In a preferred embodiment, the swivel arm arrangement includes a first swivel arm 7, a second swivel arm 9 and a third swivel arm 16. The first swivel arm 7 is pivotally connected to the second gear 4 via a pin 6. The second swivel arm 9 is pivotally connected to the first swivel arm 7 via a pin 8. A shaft 12 is fixedly secured at a shaft first end 10 to the second swivel arm 9. The shaft 12 is pivotally attached at a shaft second end 28 to the third swivel arm 16. The shaft 12 is housed within the angled neck 29 and is generally parallel with the longitudinal axis 39.

A guide spacer 11 is located within the angled shaft 29 and surrounds the shaft 12 adjacent the first end 10 of the shaft 12 to minimize lateral movement of the shaft 12. A second guide spacer 13 is located adjacent the second end 28 of the shaft 12 to also minimize lateral movement of the shaft 12. Guide spacers 11, 13 align the shaft 12 within the angled shaft 29 and minimize its movement from side to side within the angled shaft 29.

The third swivel arm 16 has a first end 15 and a second end 18. The third swivel arm 16 is pivotally connected to the second guide spacer 13 at the first end 15 via a pin 14. The third swivel arm 16 is connected at the second end 18 to the bristle supporting structure 24 via a pin 19. The pin 19 is connected to a disk 21 of the bristle supporting structure 24 which is housed within the head 23.

As the first gear 2 rotates, the second gear 4 is rotated, thus moving the lower end of first swivel arm 7 in a circular fashion about the circular path of movement of pin 6 as the opposite upper end of the first swivel arm 7 moves in a linear reciprocating motion generally along the longitudinal axis 39. The first swivel arm 7 retains its orientation of approximately parallel to the longitudinal axis 39 of the elongated body portion 30 during movement. The second swivel arm 9 pivots with respect to its pin connection 8 with the first swivel arm 7 thus allowing the shaft 12 to reciprocate in a back and forth manner toward and away from the brush head with minimal lateral motion.

During operation, the third swivel arm 16 moves back and forth along the longitudinal axis 39 of the elongated body portion 30 along with the shaft 12. The third swivel arm 16 has an offset arm 17 which is offset from the longitudinal axis 39 and moves the disk 21 of the bristle supporting structure 24 in a partially rotating or oscillating motion. As the third swivel arm 16 moves back and forth, the offset arm 17 moves along an outside edge 20 of the disk 21 in a partially rotating or oscillating fashion about an axis which is approximately normal to the longitudinal axis 39. This causes the bristles 25 to also move in a partially rotating or oscillating manner about a central rotational axis 102 approximately normal to the longitudinal axis 39. When the third swivel arm 16 moves back and forth, the disk 21 rotates about the central rotational axis 102. The third swivel arm 16 also retains its orientation of approximately parallel to the elongated body portion longitudinal axis 39 during movement.

The head 23 has a first end 26, a second end 22 and a bottom plate 34. The bristle supporting structure 24 is movably fitted to the head 23 and extends through the bottom plate 34. The bristle supporting structure 24 oscillates about the central rotational axis 102 and has bristles 25 which extend outwardly and generally parallel to the central rotational axis 102. Referring to FIGS. 1B, 1C and 1D the swivel arm 16 is pivotally attached to a rotatable disk 21 by a pin 19. When the swivel arm 16 moves back and forth, bristle member 101 is rotated and counter-rotated. A solid threaded cylinder 38 is attached to disk 21 at one end and to a circular bristle supporting structure 24 at the opposite end. Tufts of bristles 25 are arranged in a circular pattern on bristle supporting member 24. A hollow cylinder 35 (having threads 36 on its internal walls) is attached to bottom plate 34 of brush head 23. Central axis of disk 21, cylinder 38 bristle supporting structure 24 and cylinder 35 is the same. When the disk 21 rotates, threads 37 on solid cylinder communicate with internal threads 36 in hollow cylinder 35 and cause bristles 25 to move up and down (relative to the bottom plate 34 brush head 23) while oscillating through an arc of partial rotation. FIG. 1C illustrates the bristles 25 in an “up” position with the swivel arm 16 pulled back. FIG. 1D illustrates the bristles 25 in a “down” position with the swivel arm 16 extended and end of swivel arm 18 pivotted down while disk 21 is in a rotated position.

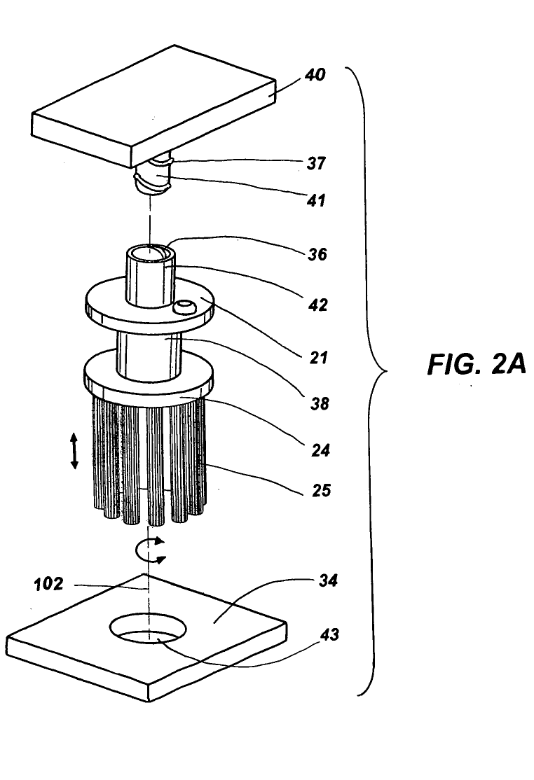

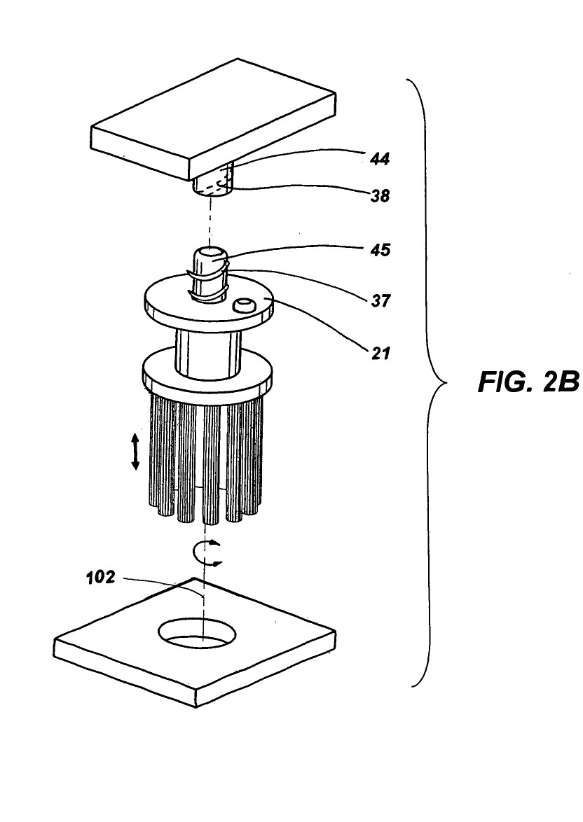

A second preferred embodiment is illustrated in FIG. 2A. A threaded solid cylinder 41 is attached to the top plate 40 of the brush head 23. A hollow cylinder 42 (having threads 36 on its internal walls) is attached to the disk 21. When swivel arm 16 (not shown) moves back and forth, disk 21 rotates and counter-rotates. When the disk 21 rotates threads 37 on the solid cylinder 41 communicate with threads 36 in the hollow cylinder 42 to cause the bristles 25 to move up and down while oscillating through an arc of rotation about central rotational axis 102. FIG. 2B illustrates an alternative arrangement in which a hollow cylinder 44 is attached to top plate 40 of brush head 23 and has threads 38 in its internal walls. A solid cylinder 45 is attached to disk 21 and has threads 37 on its external walls. When disk 21 is rotated, bristles 25 move up and down (while oscillating/rotating) when the threads 37 communicate with threads 38.

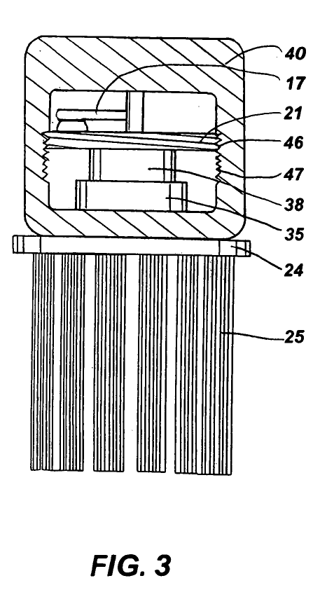

A third preferred embodiment is illustrated in FIG. 3. The outer edge of rotatable disk 21 has threads 46. The inside wall of brush head 23 also has threads 47 adapted to communicate with the threads 46 of the rotatable disk 21. When swivel arm 16 (not shown) moves back and forth disk 21 rotates and counter-rotates. When the disk 21 rotates and counter-rotates, bristles 25 move up and down while oscillating through an arc of rotation about the central rotational axis 102.

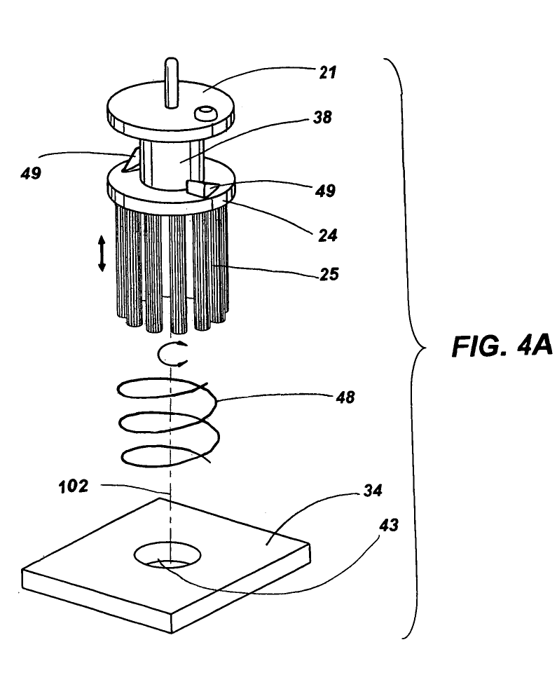

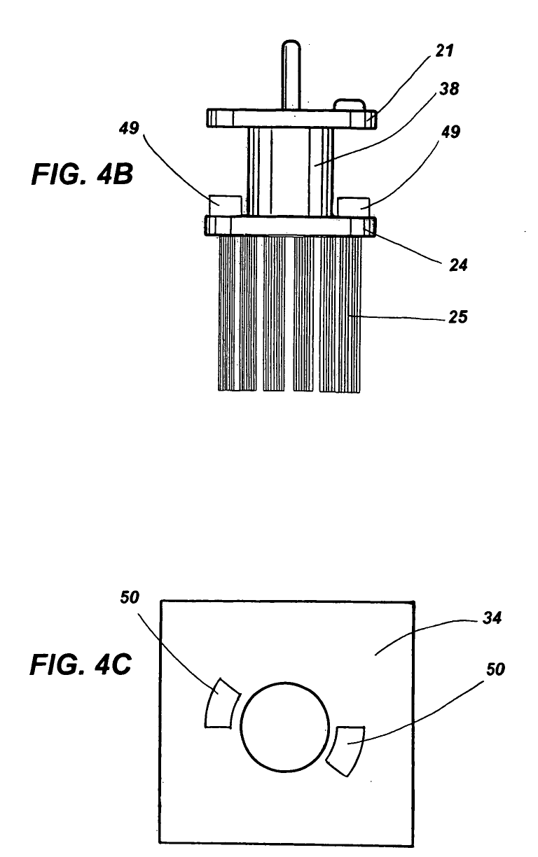

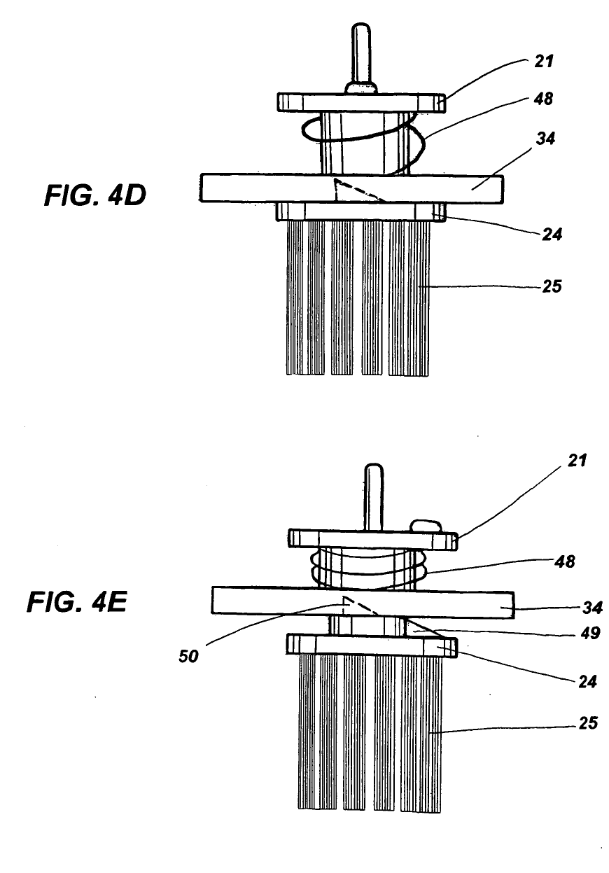

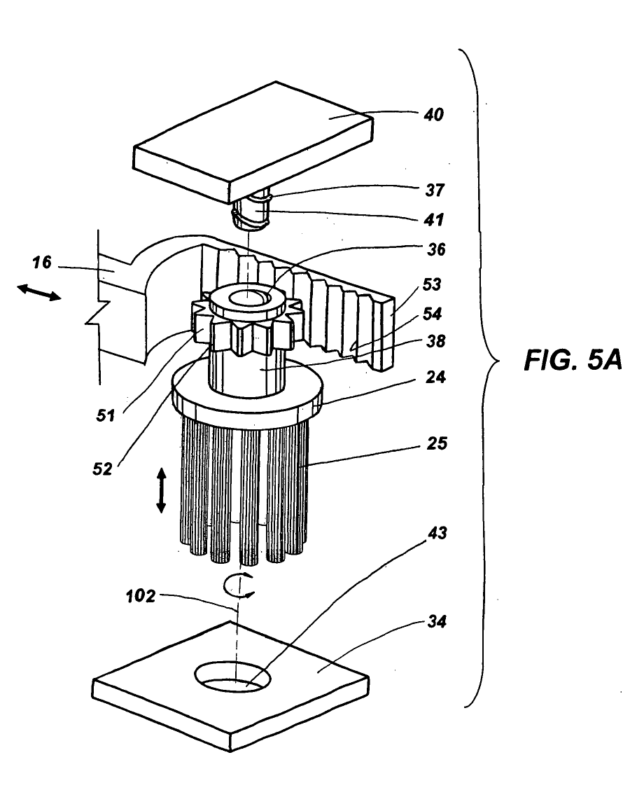

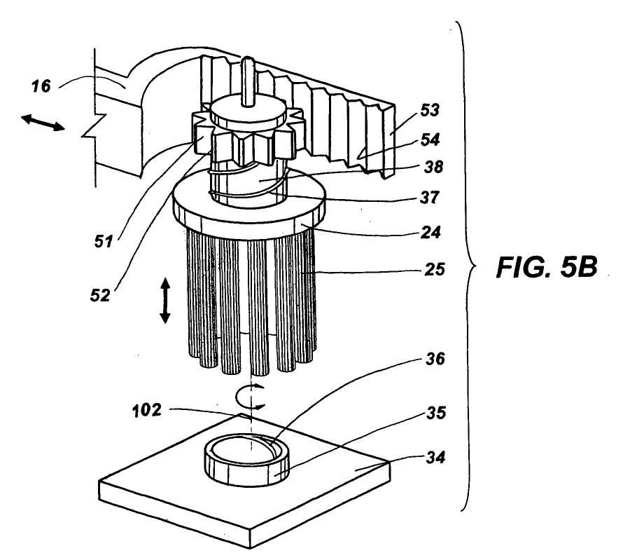

A forth preferred embodiment is illustrated in FIGS. 4A, 4B, 4C, 4D, and 4E. Referring to FIGS. 4A and 4C protruding ramps 49, located on the top surface of the bristle supporting structure 24, slide in and out of grooves 50 located on bottom surface of floor 34 of brush head 23. When the disk 21 is rotated and counter-rotated, protruding ramps 49 slide in and out of grooves 50 and force the bristle supporting structure 24 to move up and down in a linear reciprocating motion. A spring 48 lifts bristle supporting structure 24 toward bottom surface 34. FIG. 4D illustrates the bristles 25 in an “up” position where the ramps 49 are entirely fitted into grooves 50 and the spring 48 is in its relaxed state. FIG. 4E illustrates the bristles 25 in a “down” position where disk 21 is rotated, the ramps 49 have moved out of grooves 50, and the spring 48 is in its compressed state. Accordingly, as the disk 21 is rotated and counter-rotated by movement of the swivel arm assembly, the bristle supporting structure and bristles 25 are moved in the oscillating motion through an arc of rotation about the rotational axis 102, while simultaneously moving in the linear reciprocating motion parallel to the central rotational axis 102.

A fifth preferred embodiment is illustrated in FIG. 5A. Swivel arm 16 is attached to a toothed rack 53. Rack 53, generally parallel to swivel arm 16, moves back and forth when the swivel arm 16 moves back and forth. Teeth 54 on rack 53 communicate with teeth 52 on spur gear 51 to cause gear 51 to rotate and counter-rotate when the rack 53 moves back and forth. The gear 51 is attached to a hollow cylinder 38 having threads 36 on its internal walls. Hollow cylinder 38 is attached to bristle-supporting structure 24 at one end and couples with threaded solid cylinder 41 at opposite end. When the gear 51 is rotated and counter-rotated, threads 37 of solid cylinder 41 communicate with threads 36 on hollow cylinder 38 to move the bristles 25 up and down while simultaneously oscillating about an arc of rotation on the central rotational axis 102. An alternative arrangement is illustrated in FIG. 5B. A hollow cylinder 35 has threads 36 on its internal walls and is attached to floor 34. A solid cylinder 38 having threads 37 on its walls is attached to gear 51 at one end and bristle supporting structure 24 at the opposite end. When rack 53 moves back and forth, threads 37 communicate with threads 36 and cause bristles 25 to move up and down while simultaneously oscillating through the arc of rotation about the central rotational axis 102.

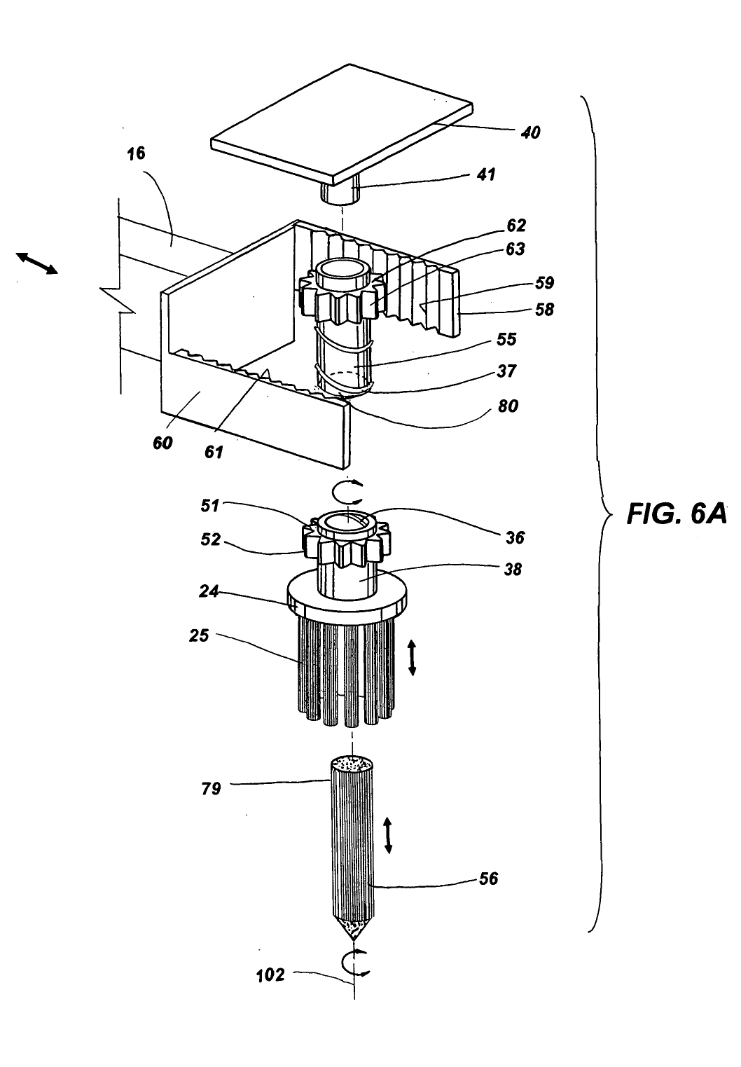

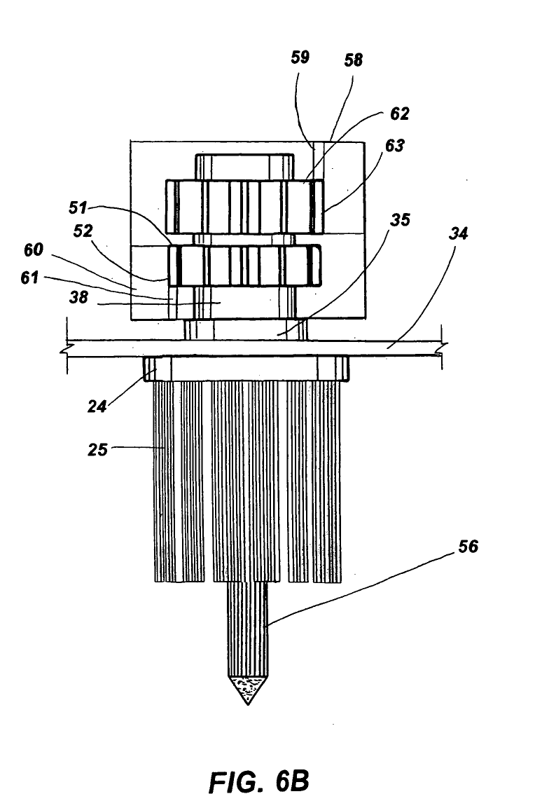

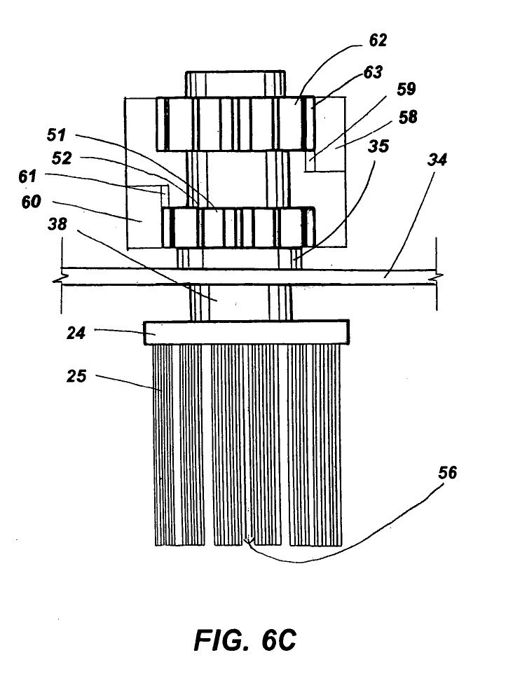

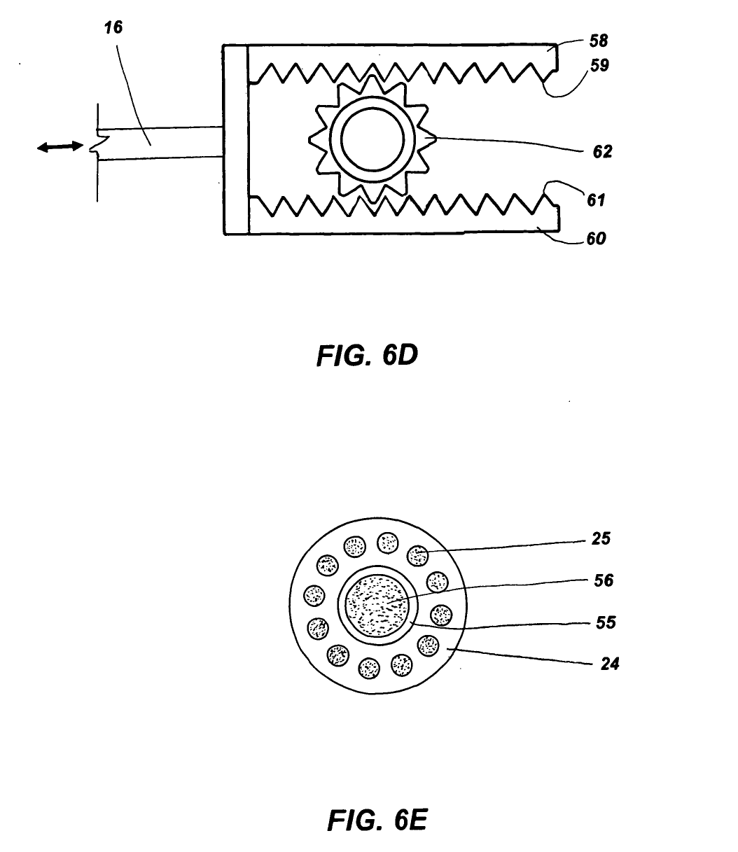

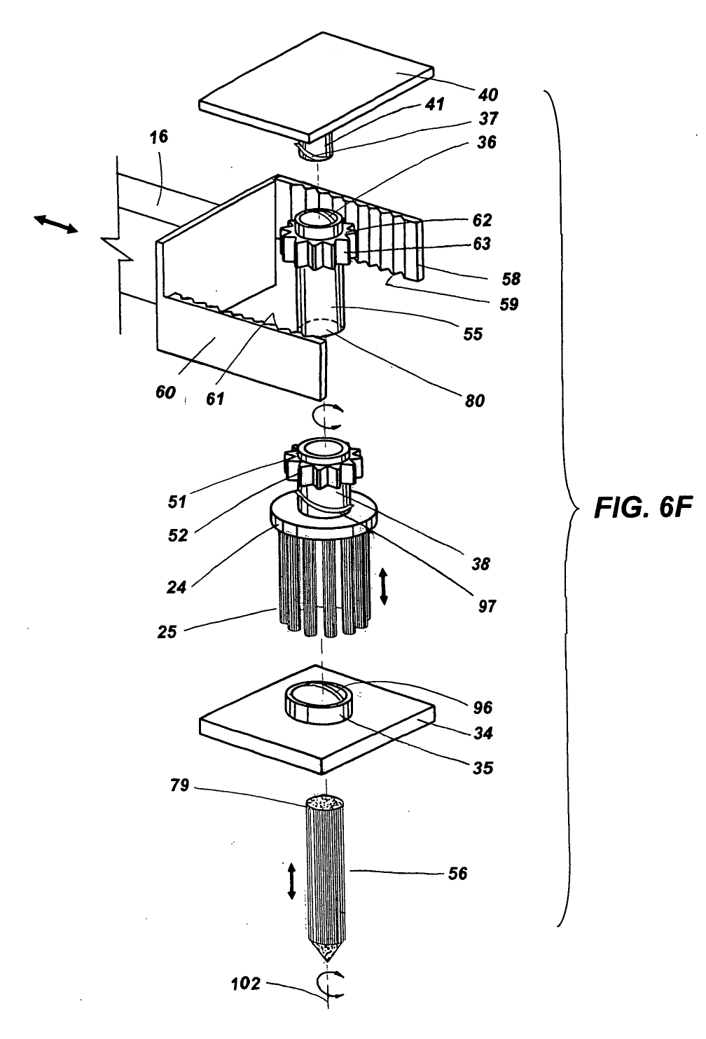

A sixth preferred embodiment is illustrated in FIGS. 6A-6F. In this embodiment, swivel arm 16 is attached to a structure having two parallel toothed rack arms (first rack arm 58 and second rack arm 60). First rack arm 58 is laterally offset from the second rack arm 60. Teeth 59 of first rack arm 58 are adapted to communicate with teeth 63 of an upper spur gear 62 and to engage the upper gear 62 in order to rotate and counter-rotate the gear 62 about the central rotational axis 102 when the rack arm 53 moves back and forth. Teeth 61 of second rack arm 60 are adapted to communicate with teeth 52 of the lower spur gear 51 to engage the lower gear 51 to rotate and counter-rotate on the same central rotational axis 102 when the rack arm 60 moves back and forth. A first hollow cylinder 55 having threads 37 on its external surface is attached to upper gear 62. One end 79 of first set of tuft of bristles 56 is adapted to be permanently fitted into hole 80 of first hollow cylinder 55. A second hollow cylinder 38 having threads 36 on its internal walls is attached to lower gear 51. Circular bristle supporting structure 24 accommodating second set of bristles 25 is attached to second hollow cylinder 38. When the swivel arm assembly moves back and forth, first and second rack arms (58 and 60 respectively) move back and forth and engage gears 51 and 62, respectively, to rotate and counter-rotate (in opposite directions from one another), thereby causing first and second set of bristles 56 and 25, respectively, to rotate and counter-rotate (in opposite directions from one another). Threads 36 and 37 on the cylinders (38 and 55 respectively) communicate to move up and down the first sets of bristles 56 while simultaneously moving up and down the second set of bristles 25 (in an opposite direction from the first set 56). FIG. 6B illustrates the first set of bristles 56 in a “down” position while the second set of bristles is in an “up” position. In this state, the first set of bristles 56 extends to its maximum length to penetrate interproximal crevices, while the second set of bristles 25 withdraws to its minimum length to allow the first set of bristles 56 to achieve its maximum penetration. FIG. 6C illustrates the first set of bristles 56 in an “up” position, while the second set of bristles is in a “down” position. In this state the second set of bristles 25 is projected to its maximum length to clean tooth surfaces, while first set of bristles 56 is withdrawn to its minimum length. FIG. 6D is a top plan view of the rack arms 58 and 60. FIG. 6E is a bottom plan view illustrating the relationship between the first set of bristles 56 with cylinder 55, bristle supporting structure 24, and the second set 25. FIG. 6F illustrates an alternative in which hollow cylinder 55 telescopically slides into hollow cylinder 38. The threads 37 of solid cylinder 41 communicate with threads 36 of cylinder 55 to move the first set of bristles 56 in an up and down direction while rotating. Threads 96 of a hollow cylinder 35 communicate with threads 97 on external wall of cylinder 38 to move the second set of bristles 25 in an up and down motion while rotating.

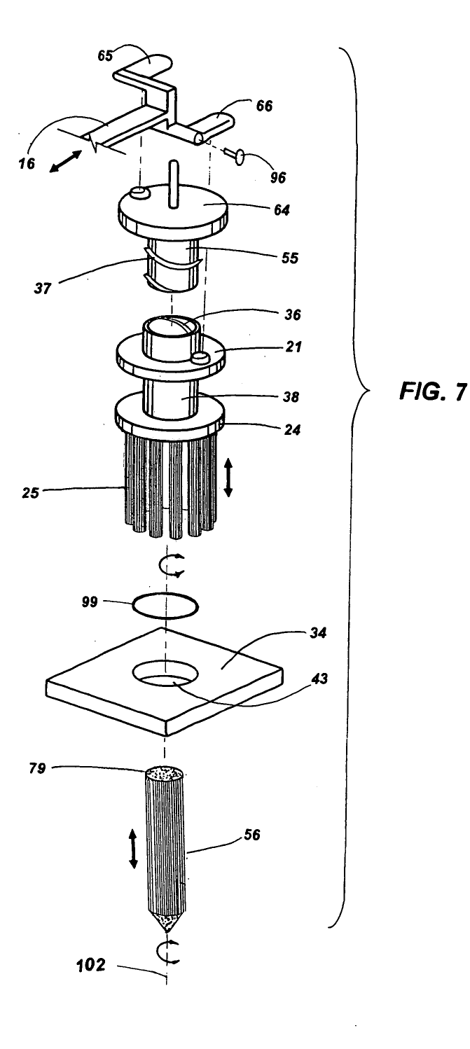

A seventh preferred embodiment is illustrated in FIG. 7. The swivel arm 16 has two side arms (first side arm 65 and second side arm 66) that are pivotally attached to swivel arm 16 thereby allowing end (that end which is attached to disks 64 and 21 respectively) of side arms 65 and 66 to move laterally up and down. First side arm 65 is pivotally attached to top disk 64 and is adapted to rotate and counter-rotate top disk 64 when it (65) moves back and forth. Second side arm 66 is pivotally attached to bottom disk 21 and rotates bottom disk 21 when it (66) moves back and forth. A hollow cylinder 38, attached to lower disk 21, has threads 36 on its internal walls. Solid cylinder 55, attached to upper disk 64, has threads 37 on its external walls. When swivel arm 16 moves back and forth, movement of side arms 65 and 66 causes upper and lower disks (64 and 21 respectively) to rotate (in opposite directions from one another). Threads 37 on solid cylinder 55 communicate with threads 36 on hollow cylinder 38 to move first and second set of bristles (56 and 25 respectively) up and down (in opposite directions from each other), while rotating about the central rotational axis 102 (in opposite directions from each other). An O-ring 99 is fitted within hole 43 to provide a seal between the hole 43 and cylinder 38, thereby preventing entry of water and foreign material into the interior of the brush head 23 during operation.

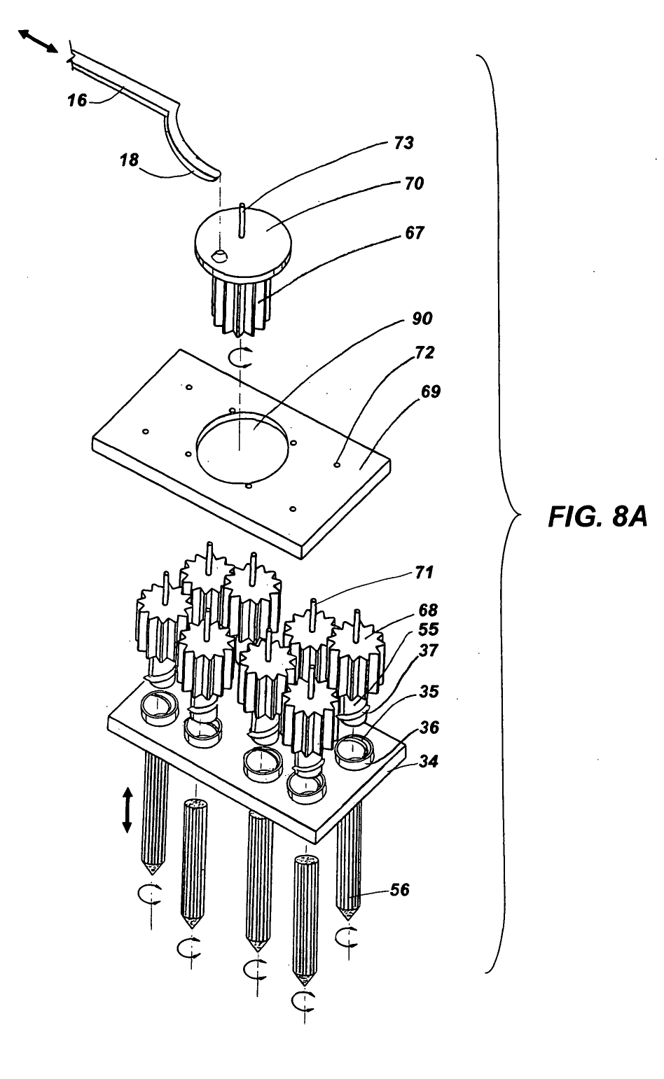

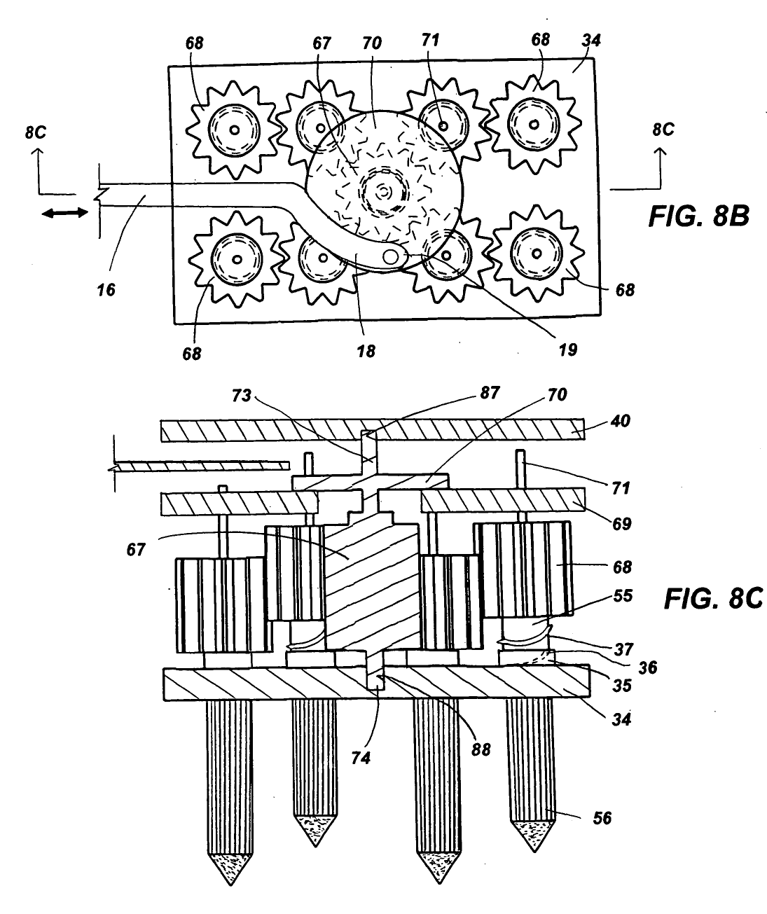

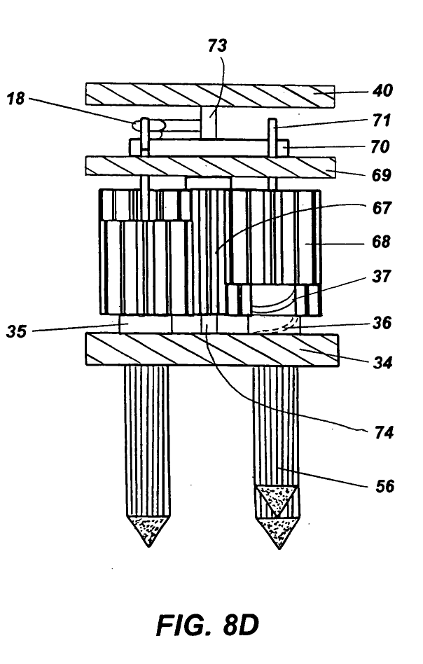

An eighth preferred embodiment is illustrated in FIGS. 8A, 8B, 8C, and 8D. Sets of bristles 56 are arranged in parallel rows on bottom plate 34 of brush head 23. Swivel arm 16 moves back and forth to rotate a disk 70 which is attached to a drive gear 67. The proximity and arrangement of adjacent spur gears 68 in relation to the drive gear 67 causes the adjacent gears 68 to rotate when the drive gear 67 rotates. A first hollow cylinder 55 attached to adjacent gears 68 has threads 37 on its external walls. A tuft of bristles 56 is permanently fitted into bottom of hollow cylinder 55. A second hollow cylinder 36 having threads 35 on its internal walls is attached to floor 34 of the brush head 23. Referring to FIG. 8C shaft end 87 of shaft 73 protruding from center of disk 70 fits into hole on top plate 40 to minimize sideway movement of drive gear 67 when the disk 70 rotates. Opposite end 74 of shaft 73 fits in hole 88 on bottom plate 34. Refering to FIG. 8A, a middle plate 69 has holes 72 positioned to allow shafts 71 extending from center of gear 68 to move up and down and provide alignment to the gears during rotation. Plate 69 has a large hole 90 to allow the drive gear to be inserted and positioned with adjacent gears 68 during assembly. When the adjacent gears 68 are rotated and counter-rotated threads 37 on the solid cylinder 55 communicate with threads 35 of the hollow cylinder 36 to move the tuft of bristles 56 up and down while rotating. Adjacent tuft of bristles 56 are in opposite (up or down) position. FIG. 8B is a top plan view with the top plate removed illustrating the relationship of the drive gear 67 with adjacent gears 68. FIG. 8C is a sectional view taken along line 8C-8C in FIG. 8B illustrating the disk 70, drive gear 67, adjacent gear 68 and plate 69. FIG. 8D is a side view illustrating the drive gear 67 in relation to the adjacent gears 68 and the up or down positions of bristles 56.

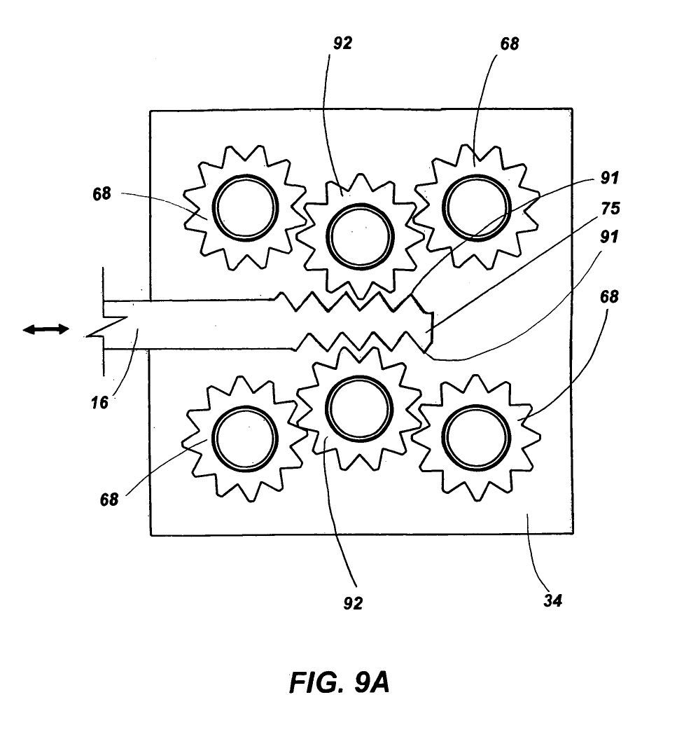

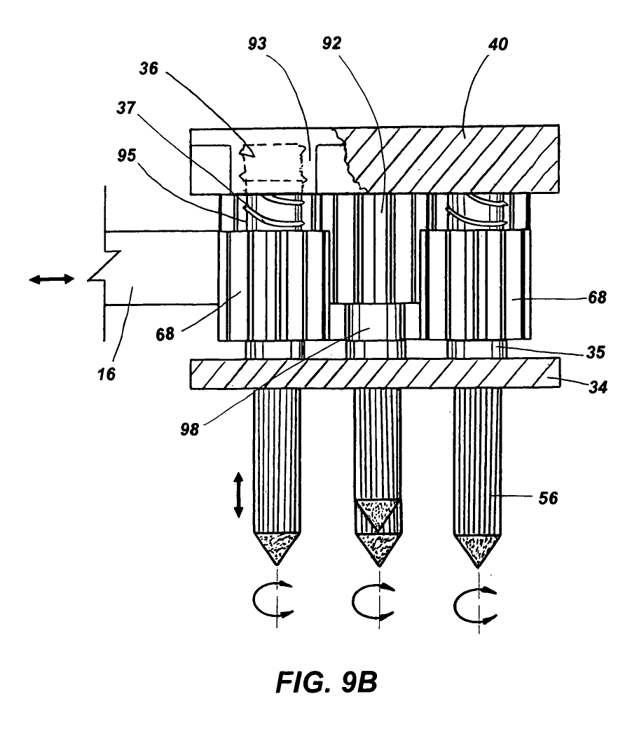

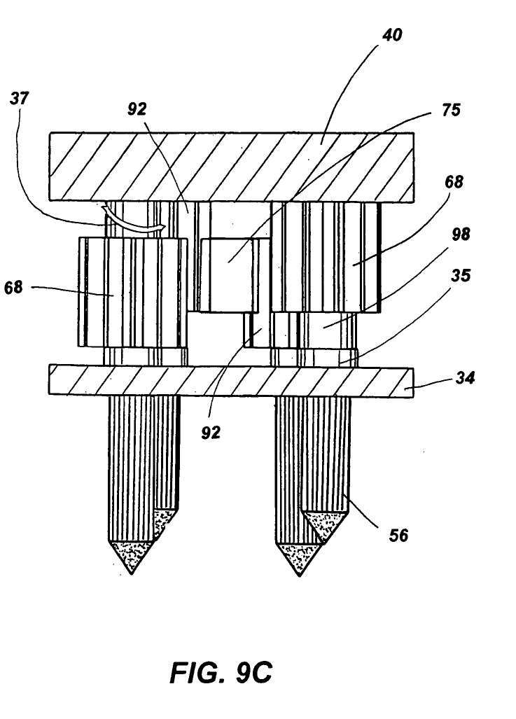

A ninth preferred embodiment is illustrated in FIGS. 9A, 9B, and 9C. Swivel arm 16 is attached to a rack member 75 having teeth 91 on both sides. Teeth 91 on rack member 75 engage drive gears 92 to rotate when the rack member 75 moves back and forth. The proximity and arrangement of adjacent gears 68 cause adjacent gears 68 to counter-rotate when the drive gear 92 rotates. Referring to FIGS. 9B and 9C a hollow cylinder 93 attached to top plate 40 of the brush head 23 has threads 36 on its internal walls. A solid cylinder 95 having threads 37 on external walls is attached to gears 92 and 68. Tuft of bristles 56 are permanently fitted into hollow cylinder 98. When the rack 75 moves back and forth, drive gears 92 and adjacent gears 68 are rotated and counter-rotated. Threads 36 in the hollow cylinder 93 communicate with threads 37 on the solid cylinder 95 to move the bristles 56 up and down while rotating. FIG. 9C is a side view illustrating the rack 75 in relation to drive gears 92 and adjacent gears 68 and up and down positions of tuft of bristles 56.

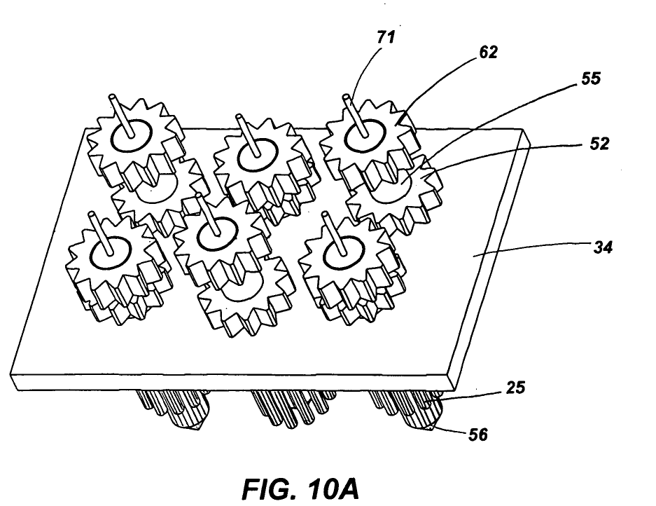

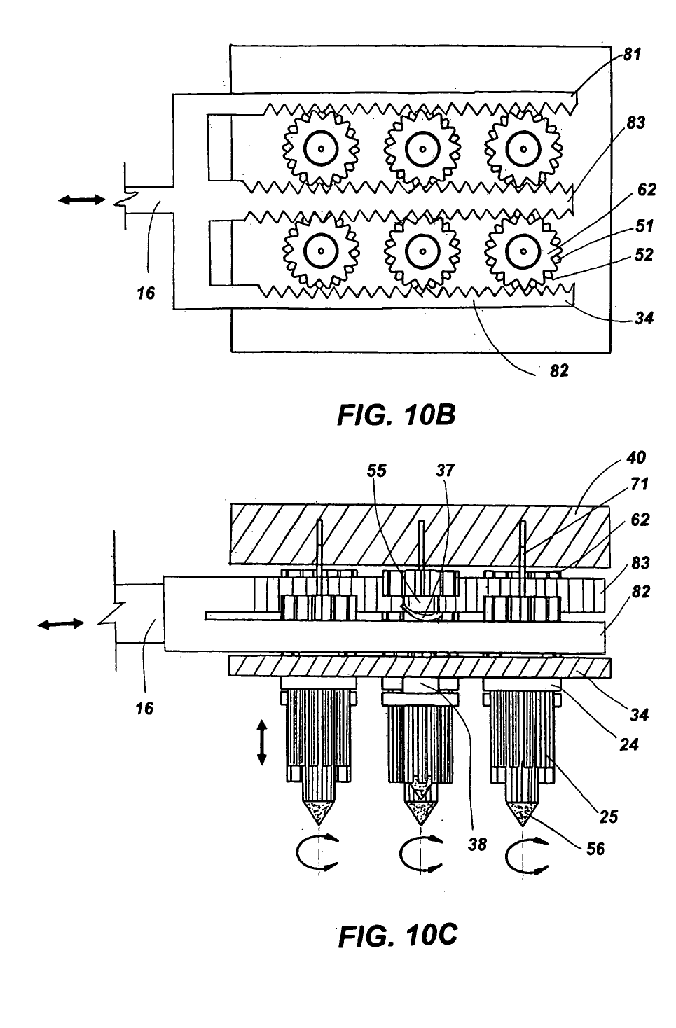

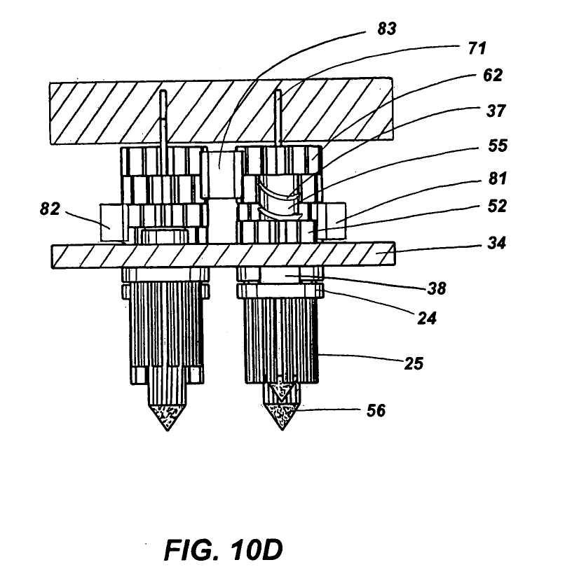

A tenth preferred embodiment is illustrated in FIGS. 10A, 10B, 10C, and 10D. Pairs of tufts of bristles (56 and 25) are arranged in parallel rows on bottom plate 34 of brush head 23. Referring to FIGS. 10B and 10C swivel arm 16 is attached to a rack-supporting structure having three parallel rack arms (81, 83, and 82). The middle rack arm 83, laterally offset from the two side rack arms (81 and 82), is adapted to engage the upper gears 62 to rotate when the rack arm 83 moves back and forth. The two side rack arms (81 and 82) are adapted to engage lower gears 52 to rotate when the rack arms (81 and 82) move back and forth. Referring to FIGS. 10C and 10D a first hollow cylinder 55, attached to upper gear 62, has threads 37 on its external walls, and is adapted to permanently fit first set of bristles 56 (designed to access interproximal crevices between teeth). A second hollow cylinder 38, attached to lower gear 52, has threads (not shown) on its internal walls. Bristle supporting structure 24 is attached to second hollow cylinder 38. Second set of bristles 25 (designed to clean tooth surfaces) is attached to bristle supporting structure 24. A shaft 71 protrudes from center of gear 62 and fits in hole in upper plate 40 to prevent sideway movements of gear 62 during rotation. When swivel arm 16 moves back and forth, middle rack arm 83 engages upper gears 62 to rotate and counter-rotate while both side rack arms 81 and 82 engage lower gears 52 to rotate and counter-rotate (in opposite direction of upper gear 62). Threads on the two cylinders (38 and 55) communicate to move the first set of bristles 56 up and down (in opposite direction of movement of second set of bristles 25) while rotating.

While the present invention has been shown and described in accordance with various preferred and practical embodiments, it is recognized that departures from the instant disclosure are fully contemplated within the spirit and scope of the invention without limitation, except as set forth in the following claims as interpreted under the doctrine of equivalents.

1. A head for a toothbrush, comprising:
a housing;
a bristle member movably fitted to said housing and including a first set of bristles;
a motion directing assembly structured and disposed for rotating said first set of bristles in an oscillating motion through an arc of rotation about a central rotational axis; and
said motion directing assembly being further structured for simultaneously moving said first set of bristles in a linear reciprocating motion and parallel to said central rotational axis.

2. The head as recited in claim 1 further comprising:
a second set of bristles movably supported on said housing of said head; and
said motion directing assembly being structured for simultaneously moving both said first set of bristles and said second set of bristles in said oscillating motion and said linear reciprocating motion.

3. The head as recited in claim 2 wherein said second set of bristles is movably supported on said central rotation axis and said motion directing assembly is structured for moving said first set of bristles in said oscillating motion in one direction through said arc of rotation about said central rotational axis while simultaneously moving said second set of bristles in said oscillating motion in an opposite direction through said arc of rotation about said central rotational axis so that said first set of bristles and said second set of bristles counter-rotate relative to one another while moving in said oscillating motion.

4. The head as recited in claim 3 wherein said motion directing assembly is further structured for simultaneously moving said first set of bristles and said second set of bristles in said linear reciprocating motion, wherein said first set of bristles and said second set of bristles are moved in opposite phase relative to one another so that when said first set of bristles is moving in one linear direction, said second set of bristles is moving in an opposite linear direction.

5. The head as recited in claim 1 further comprising:
a plurality of said first set of bristles, each of said plurality of first set of bristles being movably supported on said housing about an individual central rotational axis.

6. The head as recited in claim 4 further comprising:
a plurality of said first set of bristles movably supported on said housing;
a plurality of said second set of bristles movably supported on said housing, and each of said plurality of said second set of bristles being operatively positioned with a corresponding one of said plurality of first set of bristles so that each of said correspondingly positioned first and second set of bristles are movable about a common individual rotational axis; and
said motion directing assembly being structured for simultaneously moving said plurality of said first set of bristles and said plurality of said second set of bristles in said oscillating motion and said linear reciprocating motion.

7. A head for a toothbrush, comprising:
a housing;
a first set of bristles movably fitted to said housing on a central rotational axis;
a second set of bristles movably fitted to said housing on said central rotational axis;
a motion directing assembly structured and disposed for rotating said first set of bristles in an oscillating motion through an arc of rotation about said central rotational axis, and said motion directing assembly being further structured and disposed for rotating said second set of bristles in an oscillating motion through an arc of rotation about said central rotational axis; and
said motion directing assembly being further structured for simultaneously moving said first set of bristles and said second set of bristles in a linear reciprocating motion and parallel to said central rotational axis with said first set of bristles moving in one linear direction while said second set of bristles move in an opposite linear direction throughout said linear reciprocating motion of said first said and said second set of bristles.

8. The head as recited in claim 7 wherein said motion directing assembly is structured for moving said first set of bristles in said oscillating motion in one rotational direction about said arc of rotation while simultaneously moving said second set of bristles in said oscillating motion in an opposite rotational direction about said arc of rotation so that said first set of bristles and said second set of bristles counter-rotate relative to one another while moving in said oscillating motion.

9. The head as recited in claim 8 further comprising:
a plurality of said first set of bristles, each of said plurality of said first set of bristles being movably supported on said housing about an individual central rotational axis;
a plurality of said second set of bristles, each of said plurality of said second set of bristles being operatively positioned with a corresponding one of said plurality of said first set of bristles and movably supported on said housing about said individual central rotational axis of said corresponding one of said plurality of said first set of bristles, and each of said plurality of said first set of bristles and said plurality of said second set of bristles being movable in said oscillating motion about said individual central rotational axis, and each of said plurality of said first set of bristles and said second set of bristles being movable in said linear reciprocating motion parallel to said individual central rotational axis; and
said motion directing assembly being structured for simultaneously moving said plurality of said first set of bristles and said plurality of said second set of bristles in said oscillating motion and said linear reciprocating motion.

10. A head for a toothbrush, comprising:
a housing;
a bristle member movably fitted to said housing about a central rotational axis, and said bristle member, including a first portion with an upper disk movably captivated within said interior of said housing and a second portion disposed on an exterior of said housing, said second portion, including a bristle support structure with a first set of bristles extending outwardly therefrom and arranged in a pattern about said central rotational axis;
said bristle member further including a first cylinder member;
a second cylinder member positioned and disposed in axial alignment with said first cylinder member within said interior of said housing;
means for rotating said upper disk about said central rotational axis in an oscillating motion through an arc of rotation about said central rotational axis; and
cooperating thread means on said first and second cylinder members for directing movement of said bristle support structure and said first set of bristles in an oscillating motion through an arc of rotation about said central rotational axis upon rotation of said upper disk in said oscillating motion, and said cooperating thread means being further structured for simultaneously directing said bristle support structure and said attached first set of bristles in a linear reciprocating motion away from and back towards said housing and generally parallel to said central rotational axis.

11. A head for a toothbrush, comprising:
a housing;
a bristle member movably fitted to said housing about a central rotational axis, and said bristle member including a first portion with a top disk movably captivated within an interior of said housing and a second portion disposed on an exterior of said housing, said second portion including a bristle support structure with a first set of bristles extending outwardly therefrom and arranged in a pattern about said central rotational axis;
first thread means formed about an outer annular side surface of said top disk;
second thread means formed about said interior of said housing;
means for rotating said top disk about said central rotational axis in an oscillating motion through an arc of rotation about said central rotational axis; and
said first and second thread means cooperating with one another, in threaded engagement, for directing movement of said bristle support structure and said attached first set of bristles in an oscillating motion through an arc of rotation about said central rotational axis while simultaneously directing said bristle support structure and said first set of bristles in a linear reciprocating motion away from and back towards said housing and generally parallel to said central rotational axis upon rotation of said top disk in said oscillating motion.

12. A head for a toothbrush, comprising:
a housing;
a bristle member movably fitted to said housing about a central rotational axis, and said bristle member including a first portion with a top disk movably captivated within an interior of said housing and a second portion disposed on an exterior of said housing, said second portion including a bristle support structure with a first set of bristles extending outwardly therefrom and arranged in a pattern about said central rotational axis;
a plurality of ramp members each having an inclined surface and protruding from a top surface of said bristle support structure and said inclined surface of each of said plurality of ramp members cooperating with corresponding and congruently configured grooves formed in an outer surface of said housing;
a biasing element for urging said bristle support structure towards said outer surface of said housing so that said inclined surface of each of said ramp members is forced into engagement with said corresponding grooves;
means for rotating said top disk of said bristle member about said central rotational axis in an oscillating motion through an arc of rotation about said central rotational axis; and
said ramp members and said corresponding grooves being structured and configured for directing said bristle support structure and said attached first said of bristles in said oscillating motion through said arc of rotation about said central rotational axis while simultaneously directing said bristle support structure and said attached first set of bristles in a linear reciprocating motion away from and back towards said outer surface of said housing and generally parallel to said central rotational axis.

13. A head for a toothbrush comprising:
a housing;
a bristle member movably fitted to said housing about a central rotational axis, and said bristle member including a first portion movably captivated within an interior of said housing and a second portion disposed on an exterior of said housing, said second portion including a bristle support structure with a first set of bristles extending outwardly therefrom and arranged in a pattern about said central rotational axis;
said first portion of said bristle member further including a hollow cylinder extending upwardly from said bristle support structure and having a first gear member formed thereabout with a plurality of first gear teeth;
a fixed cylinder attached to said head on said exterior of said housing and being structured and disposed for cooperating receipt within said hollow cylinder on said bristle member;
a rack gear, including a plurality of rack teeth structured and disposed for cooperating, driven engagement with said plurality of first gear teeth of said first gear member for rotating said bristle member about said rotational axis in an oscillating motion as said rack gear is moved in a linear reciprocating motion, thereby causing oscillating motion of said first set of bristles through an arc of rotation about said central rotational axis; and
cooperating thread means formed on an exterior surface of said fixed cylinder and an interior cylindrical surface of said hollow cylinder, respectively, said cooperating thread means being structured and disposed for directing said bristle support structure and said attached first set of bristles in a linear reciprocating motion away from and back towards said housing and generally parallel to said central rotational axis as said first set of bristles is simultaneously moved in said oscillating motion.

14. A head for a toothbrush comprising:
a housing;
a bristle member movably fitted to said housing about a central rotational axis, and said bristle member including a first portion movably captivated within an interior of said housing and a second portion disposed on an exterior of said housing, said second portion including a bristle support structure with a first set of bristles extending outwardly therefrom and arranged in a pattern about said central rotational axis;
said first portion of said bristle member including a hollow cylinder extending upwardly from said bristle support structure and including an inner cylindrical surface and a first gear member formed thereabout with a plurality of first gear teeth;
a floating cylinder member rotatably fitted within said interior of said head and said floating cylinder member including an exterior cylindrical surface with a second gear member formed thereabout including a plurality of second gear teeth, and said floating cylinder member being structured and disposed for receipt within said hollow cylinder on said bristle member;
a second set of bristles attached to and extending from said floating cylinder member and outwardly through said bristle support structure along said central rotational axis so that said first set of bristles is positioned in surrounding relation to said second set of bristles;
a rack gear assembly, including a first lower rack gear with a plurality of first rack gear teeth structured and disposed for intermeshing driven engagement with said first gear teeth of said first gear member and a second upper rack gear laterally offset relative to said first lower rack gear, said second upper rack gear member including a plurality of second rack gear teeth structured and disposed for intermeshing, driven engagement with said second gear teeth of said second gear member on said floating cylinder member;
said first lower rack gear drivingly engaging said first gear member on said bristle member for rotating said first set of bristles in an oscillating motion about said central rotational axis, and said second upper rack gear drivingly engaging said second gear member on said floating cylinder for simultaneously rotating said second set of bristles in an oscillating motion about said central rotational axis and in an opposite rotational direction relative to said first set of bristles; and
cooperating thread means formed about said exterior cylindrical surface of said floating cylinder member and said inner cylindrical surface of said hollow cylinder on said bristle member for driving said second set of bristles in a linear reciprocating motion outwardly away from said housing and back towards said housing so that said second set of bristles move outwardly relative to said first set of bristles and inwardly relative to said first set of bristles as said first lower rack gear and said second upper rack gear drivingly engage said first and second gear members; and
means for moving said rack gear assembly, including said first lower rack gear and said second upper rack gear, in a linear reciprocating motion for drivingly engaging said first and second gear teeth of said first and second gear members, respectively.

15. A head for a toothbrush comprising:
a housing;
a bristle member movably fitted to said housing about a central rotational axis, and said bristle member including a first portion movably captivated within an interior of said housing and a second portion disposed on an exterior of said housing, said second portion including a bristle support structure with a first set of bristles extending outwardly therefrom and arranged in a pattern about said central rotational axis;
a first hollow cylinder member fixed to said bristle member and extending upwardly therefrom in axial alignment with said central rotational axis and including an open top and a hollow interior with an inner cylindrical surface;
a first disk member fixed about said first hollow cylinder member in axial alignment with said central rotational axis;
a second floating cylinder member having an outer cylindrical side surface;
a second disk member fixed to a top of said second floating cylinder member;
cooperating thread means on said inner cylindrical surface of said first cylinder member and said outer cylindrical surface of said second floating cylinder member for vertically moving said second floating cylinder member relative to said first cylinder member along said central rotational axis upon rotating said second disk member and said second floating cylinder member relative to said first cylinder member;
a second set of bristles attached to and extending from a bottom end of said second floating cylinder member and outwardly through said bristle support structure along said central rotational axis so that said first set of bristles is positioned in surrounding relation to said second set of bristles;
a first arm member pivotally attached to said first disk member and a second arm member pivotally attached to said second disk member; and
means for moving said first and second arm members to rotate said first and second disk members in an oscillating motion about said central rotational axis such that said first set of bristles and said second set of bristles are moved simultaneously in an oscillating motion through an arc of rotation about said central rotational axis and in opposite rotational directions relative to one another while said cooperating thread means causes said first set of bristles and said second set of bristles to simultaneously move in a liner reciprocating motion, parallel to said rotational axis, with said first set of bristles moving in one linear direction while said second set of bristles move in an opposite linear direction throughout said linear reciprocating motion.

16. The head as recited in claim 15 further comprising:
a seal about an outer cylindrical surface of said first cylinder member to provide a watertight seal between said first cylinder member and said housing and preventing entry of water and foreign material into said housing.

17. A head for a toothbrush, comprising:
a housing;
a primary drive gear rotatably supported in said housing on a main rotational axis;
means for moving said primary drive gear in an oscillating motion about said main rotational axis;
a plurality of bristle members each movably fitted to said housing about an independent rotational axis, and each of said plurality of bristle members including a first cylindrical member with an outer cylindrical surface disposed in axial alignment with said independent rotational axis, a secondary gear above said cylinder member and in axial alignment with said independent rotational axis, and a first set of bristles extending from a bottom end of said first cylinder member along said independent rotational axis and outwardly from said housing;
a plurality of second hollow cylinder members fixed to said housing, and each of said plurality of second cylinder members being operatively positioned in corresponding alignment with one of said plurality of bristle members and in surrounding relation to said outer cylindrical surface of said first cylinder member;
cooperating thread means on said outer cylindrical surface of said first cylinder member of each of said plurality of bristle members and an inner cylindrical surface of each of said plurality of second cylinder members for moving each of said first cylinder members and said first set of bristles in a linear direction along said independent rotational axis upon rotation of said first cylinder member of each of said plurality of bristle members;
said secondary gear members of each of said plurality of bristle members positioned and disposed in intermeshing driven engagement with said primary drive gear so that movement of said primary drive gear in said oscillating motion through an arc of rotation about said main rotational axis results in driven oscillating motion of each of said plurality of bristle members through an arc of rotation about said independent rotational axis and rotational movement of said first set of bristles in an oscillating motion about said independent rotational axis of each of said bristle members as said first set of bristles of each of said plurality of bristle members are simultaneously moved in a linear reciprocating motion along said independent rotational axis away from and back towards said housing.

18. The head as recited in claim 17 wherein said means for moving said primary drive gear in said oscillating motion comprises:
a disk fixed about said main rotational axis and disposed in axial alignment with said main rotational axis;
an arm member pivotally attached to said disk; and
means for moving said arm member in a reciprocating motion to move said disk through an arc of movement about said main rotational axis in an oscillating motion.

19. The head as recited in claim 17 further comprising:
a first set of said plurality of bristle members and a second set of said plurality of bristle members, said first set of said plurality of bristle members being laterally offset relative to said second set of said plurality of bristle members so that when said first set of bristles on said first set of bristle members move outwardly away from said housing, said first set of bristles on said second set of bristle members move inwardly towards said housing and, further, when said first set of bristles on said first set of bristle members move inwardly towards said housing, said first set of bristles on said second set of bristle members move outwardly away from said housing throughout said linear reciprocating motion.

20. A head for a toothbrush comprising:
a housing;
a rack gear positioned within said housing;
means for moving said rack gear in a linear reciprocating motion;
a plurality of bristle members each movably fitted to said housing about an independent rotational axis, and each of said plurality of bristle members including a cylinder member with an outer cylindrical surface disposed in axial alignment with said independent rotational axis, a gear formed about said cylinder member and in axial alignment with said independent rotational axis, and a first set of bristles extending from a bottom end of said cylinder member along said independent rotational axis and outwardly from said housing;
cooperating thread means on said outer cylindrical surface of said cylinder member of each of said plurality of bristle members and said housing for moving said cylinder members and said first set of bristles of said plurality of bristle members in a linear direction along said independent rotational axis upon rotation of said cylinder members of said plurality of bristle members; and
said rack gear, including a plurality of rack gear teeth disposed in driven engagement with said gears on said cylinder members of said plurality of bristle members for drivingly rotating said plurality of cylinder members and said first set of bristles of said plurality of bristle members in an oscillating motion through an arc of rotation about said independent rotational axis.

21. A head for a toothbrush comprising:
a housing;
a plurality of bristle members movably fitted to said housing and each of said plurality of bristle members being supported on an individual rotational axis;
each of said plurality of bristle members including a bristle support structure with a first set of bristles extending outwardly therefrom and arranged in a pattern about said individual rotational axis;
each of said plurality of bristle members further including a hollow cylinder extending upwardly from said bristle support structure and including a first gear member formed thereabout with a plurality of first gear teeth;
a plurality of floating cylinder members, each one of said plurality of floating cylinder members being operatively associated with an individual one of said plurality of bristle members to define a corresponding pair, and each of said floating cylinder members being movably supported on said individual rotational axis of said one of said plurality of bristle members of said corresponding pair;
each of said floating cylinder members including an outer cylindrical surface with a second gear member formed thereabout, including a plurality of second gear teeth, and each of said plurality of floating cylinder members being structured and disposed for receipt within said hollow cylinder of said associated bristle member in said corresponding pair;
a second set of bristles attached to and extending from each of said plurality of floating cylinder members, and said second set of bristles on each of said plurality of floating cylinder members extending outwardly through said bristle support structure of said associated bristle member along said individual rotational axis so that said first set of bristles in each corresponding pair is positioned in surrounding relation to said second set of bristles in each corresponding pair;
a rack gear assembly including at least one lower rack gear with a plurality of first rack gear teeth structured and disposed for intermeshing driven engagement with said first gear teeth of said first gear member and at least one upper rack gear laterally offset relative to said at least one lower rack gear, said upper rack gear including a plurality of second rack gear teeth structured and disposed for intermeshing, driven engagement with said second gear teeth of said second gear member of each of said plurality of floating cylinder members in each of said corresponding pairs;
said at least one lower rack gear drivingly engaging said first gear member on each of said plurality of bristle members for rotating said first set of bristles of each of said plurality of bristle members in an oscillating motion about said individual rotational axis in each of said corresponding pairs, and said at least one upper rack gear drivingly engaging said second gear member on each of said plurality of floating cylinder members for simultaneously rotating said second set of bristles of each of said plurality of floating cylinder members in an oscillating motion about said individual rotational axis of each of said corresponding pairs and in an opposite rotational direction relative to said first set of bristles;
cooperating thread means on said hollow cylinder of each of said plurality of bristle members and each of said plurality of floating cylinder members in each of said corresponding pairs for driving said second set of bristles in a linear reciprocating motion outwardly away from said housing and back towards said housing so that said second set of bristles in each of said corresponding pairs move outwardly and inwardly relative to said first set of bristles in said corresponding pair; and
means for moving said rack gear assembly, including said at least one lower rack gear and at least one upper rack gear, in a linear reciprocating motion for drivingly engaging said first and second gear teeth of said first and second gear members in each of said corresponding pairs.

22. A head for a toothbrush, comprising:
a housing;
a plurality of first sets of bristles, each of said plurality of said first sets of bristles being movably supported on said housing about an individual central rotational axis;
a plurality of second sets of bristles, each of said plurality of said second sets of bristles being operatively positioned with a corresponding one of said plurality of said first sets of bristles and movably supported on said housing about said individual central rotational axis of said corresponding one of said plurality of said first sets of bristles, and each of said correspondingly positioned first and second sets of bristles defining one of a plurality of bristle hairs; and
a motion directing assembly structured and disposed for rotating each of said plurality of said bristle pairs in an oscillating motion about said individual central rotational axis corresponding to each of said plurality of said bristle pairs, and said motion directing assembly being further structured and disposed for simultaneously moving each of said plurality of said bristle pairs in a linear reciprocating motion and parallel to said central rotational axis corresponding to each of said plurality of said bristle pairs so that said first set of bristles in each bristle pair is moving in a linear direction while said second set of bristles in each of said bristle pairs is moving in an opposite linear direction throughout said linear reciprocating motion.

23. The head as recited in claim 22 wherein said motion directing assembly is structured for moving said first set of bristles in each of said bristle pairs in said oscillating motion in one rotational direction about said arc of rotation while simultaneously moving said second set of bristles in each of said bristle pairs in said oscillating motion in an opposite rotational direction about said arc of rotation so that each of said first set of bristles counter-rotate relative to said corresponding second set of bristles in each of said bristle pairs.

24. The head as recited in claim 22 wherein each of said second sets of bristles is arranged in a tuft along said individual central rotational axis of said bristle pair.

25. The head as recited in claim 23 wherein said plurality of said first sets of bristles and said motion directing assembly are structured and disposed for moving a first portion of said first sets of bristles in said linear reciprocating motion in one linear direction while simultaneously moving a second portion of said first sets of bristles in said linear reciprocating motion and in an opposite linear direction relative to said first portion of said first sets of bristles.

26. The head as recited in claim 23 wherein said plurality of said second sets of bristles and said motion directing assembly are structured and disposed for moving a first portion of said plurality of said second sets of bristles in said linear reciprocating motion in one linear direction while simultaneously moving a second portion of said plurality of said second sets of bristles in said linear reciprocating motion and in an opposite linear direction relative to said first portion of said plurality of said second second sets of bristles.
